(19) United States
(12) Patent Application Publication
(10) Pub. No.: US 2024/0095769 A1
(43) Pub. Date: Mar. 21, 2024

(54) ECO-FEEDBACK AND GAMING PLATFORM FOR HOME ENERGY MANAGEMENT

(71) Applicant: Purdue Research Foundation, West Lafayette, IN (US)

(72) Inventors: James Edward Braun, West Lafayette, IN (US); Julia Michelle Rayz, West Lafayette, IN (US); Panagiota Karava, West Lafayette, IN (US); Ilias Bilionis, West Lafayette, IN (US); Hemanth Devarapalli, West Lafayette, IN (US); Huijeong Kim, West Lafayette, IN (US); Sang Woo Ham, Berkeley, CA (US); Vanessa Kwarteng, Bloomfield, NJ (US); Marlen Promann, West Lafayette, IN (US)

(73) Assignee: Purdue Research Foundation, West Lafayette, IN (US)

(21) Appl. No.: 18/244,187

(22) Filed: Sep. 8, 2023

Related U.S. Application Data
(60) Provisional application No. 63/404,803, filed on Sep. 8, 2022.

(51) Int. Cl. G06Q 30/0207; A63F 13/798; A63F 13/80; G06Q 50/06

(52) U.S. Cl. CPC G06Q 30/0209; A63F 13/798; A63F 13/80; G06Q 50/06

(57) ABSTRACT

A system may provide an eco-feedback and gaming platform for home energy management. The system may generate daily energy scores for a plurality of households. The system may prepare a community energy conservation game in which community conservation goals and participation thresholds are generated. The system may execute the game by receiving time series date from each of the households and rewards the households for participating in achieving the community goal.

### CROSS REFERENCE TO RELATED APPLICATIONS

This application claims the benefit of U.S. Provisional Application No. 63/404,803 filed Sep. 8, 2022, the entirety of which is incorporated by reference herein.

### GOVERNMENT FUNDING

This invention was made with government support under 1737591 CNS awarded by National Science Foundation. The government has certain rights in the invention.

### TECHNICAL FIELD

This disclosure relates to energy management and, in particular, to household energy conservation management.

### BACKGROUND

Residential energy consumption is about 20% of the total energy consumption in the U.S and it is significantly affected by residents' energy-related behavior. For example, it has been shown that up to 30% of heating and cooling (HT) energy savings are possible if residents adopt efficient setpoint schedules. This may result in significant cost savings for low-income households spending a larger portion of their income (i.e., about 16%) on home energy costs than average-income households (i.e., 4%). By developing energy-saving habits, low-income residents can reduce their HC energy bill which is about 40% of their total energy cost.

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 illustrates a first example of a system.

FIG. 2 illustrates example logic for the system.

FIG. 3 illustrates example logic for generating a daily energy score for a plurality of households.

FIG. 4 illustrates an example logic for generating a personalized energy-saving action.

FIG. 5 illustrates example logic for preparing a community energy conservation game.

FIG. 6 illustrates an example of energy conservation game execution.

FIG. 7 illustrates an example of a server infrastructure.

FIG. 8 illustrates an example of a main page of a user interface.

FIG. 9 illustrates an example of an energy score page for a graphical user interface.

FIG. 10 illustrates an example of a community game page for a graphical user interface.

FIG. 11 illustrates a second example of a system.

### DETAILED DESCRIPTION

The installations of households' programmable thermostats are highly encouraged by many energy-efficiency programs and product vendors for effective HC energy management. Growing rapidly, residential programmable thermostat users are expected to reach 40% of the US population by 2021. With a thermostat's programmable features, users can effectively set up or set-back thermostat setpoints during unoccupied periods using thermostat schedules and significantly reduce their home energy usage. However, despite its benefits and increased adoption, the range of savings varies significantly depending, among others, on users' knowledge and usability of programmable features. For example, an online survey conducted by Pritoni et al. reported that about 40% of programmable thermostat users did not understand how to program thermostat schedules and about 33% maintained a permanent hold mode without using its schedule features. This aligns with the field evaluation report from Cadmus that about 32% of the programmable thermostat users had a single setpoint throughout a season. Similarly, a field experiment conducted by the U.S. Department of Energy with 64 affordable housing apartments showed that only 3.2% and 1.6% of programmable thermostat users applied nighttime and daytime setbacks, respectively. Such discrepancies between the ideal and actual usage often arise due to users' lack of understanding about the energy-conserving options in the product, misconceptions about how thermostats work, or the fear of technology failure. For instance, some residents often irrationally adjust their setpoint by assuming the space heating speed is correlated with the level of the thermostat setpoint, while some users prefer to keep their thermostat as is to avoid potential misuse. Other underlying factors related to users' lifestyles, health conditions, or properties of the building envelope that limit the usability of programmable thermostats may affect the users' thermostat misuse as well. These consequently lead users to bypass the smart programming features and downgrade their thermostats into traditional manual thermostats.

The system and methods described herein provide a cloud-based eco-feedback and gaming platform (MySmartE app) that aims to promote energy conserving thermostat adjustment behaviors in multi-unit residential buildings. The system and methods described herein provide personalized eco-feedback design integrated with a collaborative social game to assist residents enhance their thermostat use while promoting community-level energy-savings. The system and methods utilize a feedback mechanism based on 1) a new energy conservation behavior score that mathematically quantifies users' efforts in reducing HC energy usage on a normalized scale, 2) an algorithm for personalized action recommendations along with their potential impacts. To help users easily turn their perceived feedback into actions, the system provides a cloud-based app that integrates the functionality of a smart thermostat. All features are implemented in visual (wall-mounted tablet or some other type of smart device or thermostat) and voice user interfaces that facilitate behavioral changes in a user-centric approach. Based on these features, the platform is designed to help residents easily apply personalized tips to save energy.

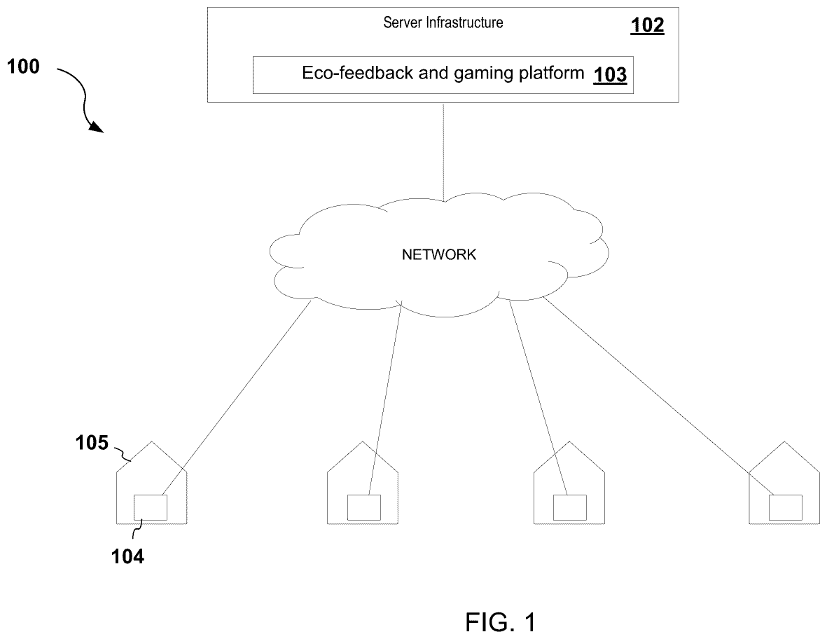

FIG. 1 illustrates a first example of a system. The system 100 may include a server infrastructure 102 which includes one or more servers, databases, and other equipment to provide the eco-feedback and gaming platform 103 and other logic described herein. The server infrastructure 102 may communicate with devices 104 located in residential households 105. The devices 104 may, for example, be tablets, smart thermostats, and/or mobile devices which are integrated into the thermostat for a home or otherwise receive information related to the HVAC system for a home. The server infrastructure 102 may communicate with multiple devices located in a community of homes. It should also be appreciated that the server infrastructure 102 may serve the devices of multiple communities of homes. Furthermore the execution of the eco-feedback and gaming platform 103 may be performed by the server infrastructure 102 or split, in part, between the device(s) 104 and the server infrastructure 102.

A community of homes is defined as either a collection of rental households where all properties are under the management of a single property management entity, or a collection of residential properties situated in close physical proximity to each other, where the majority of these homes are individually owned by their occupants.

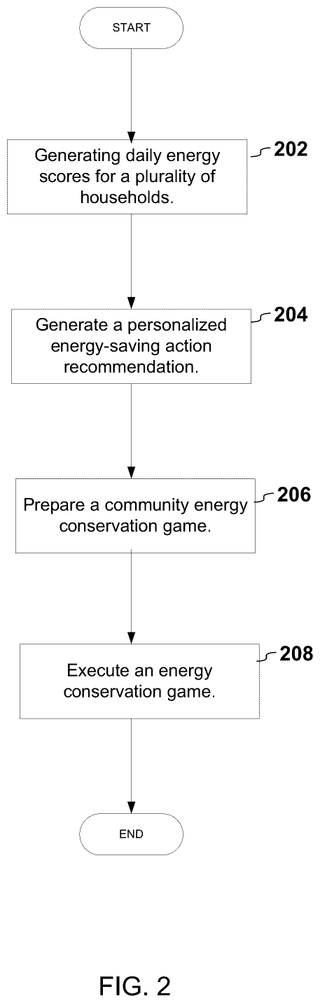

FIG. 2 illustrates example logic for the system. A methodology for personalized eco-feedback design to assist users effectively set-back or set-up thermostat setpoints using programmable features is provided. At least two types of feedback information is provided to users: 1) energy scores to inform users about their current status based on their thermostat setpoint selections and 2) personalized action recommendations with their potential impacts. A collaborative social game is then built upon the custom eco-feedback elements to promote community-level energy efficiency.

The system may generate daily personal energy score for a plurality of households (202). We define a personal energy score that mathematically quantifies users' efforts in reducing HC energy usage on a 0-100 scale, though other scales are possible. This score is generated by a server and is presented through the app on a smart device and/or thermostat every day to inform users about their progress each calendar week (i.e., from Monday to Sunday).

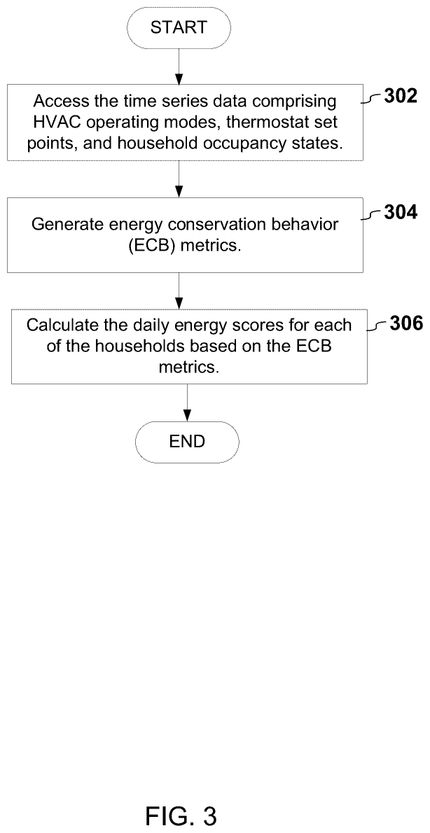

FIG. 3 illustrates example logic for generating a daily energy score for a plurality of households. The serve may access time series data collected form the households (302). The time series data may include, among other information, HVAC operating modes, thermostat set points, and household occupancy states. The series data may be communicated from the households to the server. For example, a the thermostat at each of the households may be connected a network and/or the internet and provide the time series data to the server.

The system may generate energy conservation behavior metrics (304). The energy conservation behavior (ECB) metric may evaluate the household's thermostat setpoint observed in each timestamp. The metric may be scaled between 0 and 100 to denote the worst possible behavior with 0 and the best possible with 100. Other normalized scales are possible. The ECB is a function of time-series data from 1) system operation mode Oₜ (Oₜ∈ [symbol] , [symbol] ={“heat”, “cool”, “off” }), 2) thermostat setpoint used in the mode T_{O}_{ₜ}_{,t} (T_{O}_{ₜ}_{,t}∈ [symbol] , [symbol] =[60, 90] in ° F.), and 3) occupancy state Sₜ (Sₜ∈ [symbol] , [symbol] ={“home”, “away”, “sleep” }) at timestamp t. The three-state occupancy state Sₜ is derived using logic in Appendix. A with the inputs from the thermostat and power meter data. The building block of the energy score is the ECB that accrues over a 5-minute interval in the evaluation timeframe.

Let O_{1:N}, T_{1:N}, and S_{1:N} be the observed operation modes, setpoints, and occupancy states, respectively, over the N timesteps. The energy score a is a function of these three tuples:

$$α ( {O}_{1 : N} , {T}_{1 : N} , {S}_{1 : N} ) = \frac{1}{N} {\sum }_{t = 1}^{N} {ECB}_{{S}_{t} , {O}_{t}} ( {T}_{{O}_{t} , t} ) , \qquad ( ) 1 )$$

where the summand, ECB_{s,o}(T_{o,t}), is the ECB at timestamp t for the state s∈ [symbol] and the mode o∈ [symbol] . The latter has the following generic form:

$${ECB}_{s , o} ( {T}_{o} ) = \{ \begin{matrix}100 sigmoid ( {a}_{s , o} + {β}_{s , o} {T}_{o} ) , & if o = “ heat ” or “ cool ” \\ 100 , & otherwise\end{matrix} , \qquad ( 2 )$$

where ECB_{s,o}(Tₒ) is a mode-and-state-specific ECB for the mode o, setpoint temperature Tₒ∈ [symbol] and the state s. When o is “heat” or “cool,” a sigmoid function with the shape parameters a_{s,o} and β_{s,o} evaluates the observed thermostat setpoint for the given o (i.e., Tₒ). The shape parameters are obtained by solving equations (3) and (4) analytically for a_{s,o} and β_{s,o}:

(1+e^{a}^{_{s,o}}^{+β}^{_{s,o}}^{T}^{_{s,o,H}})⁻¹=95, (3)

(1+e^{a}^{_{s,o}}^{+β}^{_{s,o}}^{T}^{_{s,o,L}})⁻¹=5, (4)

where T_{s,o,H} and T_{s,o,L} are the upper and lower setpoint thresholds that ensure 95 and 5 ECB scores for specific o and s. The threshold setpoints are selected based on ASHRAE Standard 55 and programmable thermostat user guides to guide occupants to save energy without sacrificing their thermal comfort. The threshold temperatures and ECB_{s,o} curves for the heating and cooling operation modes are presented in Table 1 and Error! Reference source not found. When the system is off, a full score of 1 is assigned.

TABLE 1
Threshold setpoints of state-specific ECB curves (unit: ° C.)

| | Mode | | | |
|---|---|---|---|---|
| | Cooling | | Heating | |
| | Lower | Upper | Lower | Upper |
| State | threshold | threshold | threshold | threshold |
| Home | 20 (68° F.) | 23.3 (74° F.) | 27.8 (82° F.) | 23.3 (74° F.) |
| Sleep | 22.2 (72° F.) | 25.6 (78° F.) | 25.6 (78° F.) | 21.1 (70° F.) |
| Away | 24.4 (76° F.) | 27.8 (82° F.) | 23.3 (74° F.) | 18.9 (66° F.) |

The system calculates the daily energy scores for the households based on the ECB metrics (306). After calculating ECB_{s,o} over the N time steps, we can decompose the energy score (Eq. (1)) according to the operating mode and occupancy state. Such decomposition helps to understand the contributions of the user's state-and-mode-specific behaviors to the current energy score. For this, Eq. (1) can be re-written using the following equation:

$$α ( {O}_{1 : N} , {T}_{1 : N} , {S}_{1 : N} ) = \frac{1}{N} {\sum }_{s ∈ 𝒮 , o ∈ 𝒪} ( {\sum }_{t = 1}^{N} {I}_{s} ( {S}_{t} ) {I}_{o} ( {O}_{t} ) ) {ECB}_{s , o} ( {O}_{1 : N} , {T}_{1 : N} , {S}_{1 : N} ) , \qquad ( 5 )$$

where Iₛ and Iₒ are the indicator functions that satisfy the following conditions for the state s and the mode o:

$${I}_{s} ( x ) = \{ \begin{matrix}1 , if x = s \\ 0 , if x \neq s\end{matrix} and {I}_{o} ( x ) = \{ \begin{matrix}1 , if x = o \\ 0 , if x \neq o\end{matrix} .$$

To get the same result as in Eq. (1), we must define the following equation:

$${α}_{s , o} ( {O}_{1 : N} , {T}_{1 : N} , {S}_{1 : N} ) = \frac{1}{{\sum }_{t = 1}^{N} {I}_{s} ( {S}_{T} ) {I}_{o} ( {O}_{t} )} {\sum }_{t = 1}^{N} {I}_{s} ( {S}_{t} ) {I}_{o} ( {O}_{t} ) {ECB}_{s , o} ( {T}_{{O}_{t} , t} ) . \qquad ( 6 )$$

Then, using Eq. (5), we update the energy score each day using data collected from the current week (i.e., from the previous Sunday to the end of the previous day). In this way, we can inform users about their daily progress during the calendar week. Eventually, the users get their final weekly score at the end of the week (i.e., Sunday).

Referring back to FIG. 2, the system may generate a personalized energy-saving recommendation (204). A mathematical framework is provided to generate a personalized message that informs users about the best action that could have resulted in the highest increase in their energy score. The framework consists of the following steps: 1) defining the concept of messages; 2) estimating the effect of messages, and 3) framing action recommendations.

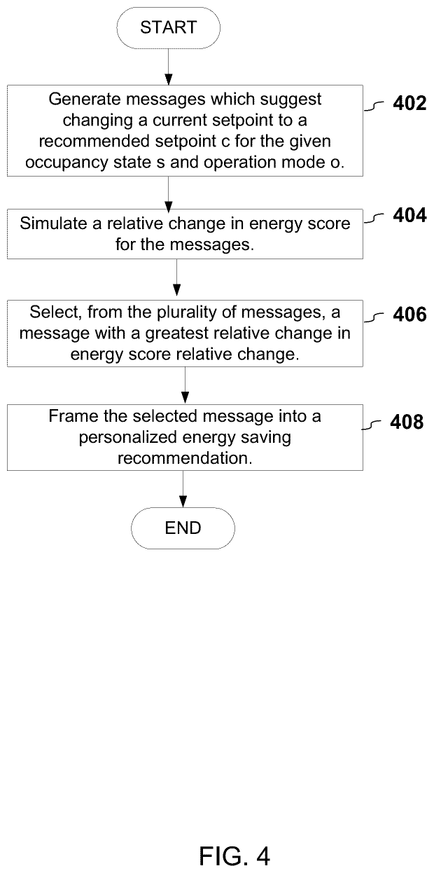

FIG. 4 illustrates an example logic for generating a personalized energy-saving action. The system may generate messages which suggest changing a current setpoint to a recommended setpoint c for the given occupancy state s and operation mode o (402).

Definition 1. A generic message is a function from the space of operation mode, setpoints, and occupancy states to the space of setpoints. Mathematically, a generic message is a map:

m: [symbol] × [symbol] × [symbol] × [symbol] . (7)

Messages defined as above are too complicated to communicate. Thus, it is useful to define a message concept that only suggests changes in a setpoint related to only one occupancy state and operation mode. We will call such a message a simple message.

Definition 2. A simple message m pertaining to occupancy state s∈ [symbol] and operation mode o∈( [symbol] −{“off” }), is a message that suggests changing the current setpoint τ∈ [symbol] to the recommended setpoint c for occupancy state s and operation mode o, and does not suggest a setpoint change for the states different than s and modes different than o. The setpoint c refers to the upper threshold setpoint used in mode-and-state-specific ECB (T_{s,o,H} in Eq. (2)). Mathematically, m is:

m(o,s,τ)=c, (8)

while restricted on the set [symbol] ×( [symbol] −{s})×( [symbol] −{o}) it becomes the identity map, i.e.,

m(s′,o′,τ)=τ, (9)

for all s′≠s and o′≠o. We will refer to such message by m_{s,o}.

The system may simulate a relative change in energy score for the messages (404). The system may select, from the messages, a message with a greatest relative change in energy score relative change (406).

After listing the type of simple messages, we estimate the effect of each message to find the one that would have had the highest positive effect on the user's energy score if implemented. For this, we define counterfactual scenarios in which the user selects the ideal setpoint c for the specific mode and state in the message. Then we calculate the counterfactual energy scores that users could have achieved by applying the message in the recent past (i.e., the previous day).

Let O_{1:n}, T_{1:n}, S_{1:n} be the observed operation modes, setpoints, and occupancy states, respectively, over the previous n timesteps of the previous day and m be a message. We can define the application of the message on the time series as follows:

m(O_{1:n},T_{1:n},S_{1:n})={(Oᵢ,m(Oᵢ,Tᵢ),Sᵢ,S)}ᵢ₌₁ⁿ, (10)

which represents the time series that results by applying the message on every element of the original time-series data. Then, we can define the relative change that could have resulted from the implementation of the messages by:

$$ρ ( {O}_{1 : n} , {T}_{1 : n} , {S}_{1 : n} ; m ) = \frac{ECB ( m ( {O}_{1 : n} , {T}_{1 : n} , {S}_{1 : n} ) ) - ECB ( {O}_{1 : n} , {T}_{1 : n} , {S}_{1 : n} )}{ECB ( {O}_{1 : n} , {T}_{1 : n} , {S}_{1 : n} )} , \qquad ( 11 )$$

where ρ is the relative change in energy score resulting from applying the message m to the observed time-series data. A positive ρ corresponds to an improvement while negative ρ represents a reduction in an energy score if implemented. The message with the highest ρ is then selected as the best action among the set of candidate simple messages [symbol] . That is, the message we select is:

$${m}^{*} = arg {max}_{m ∈ ℳ} ρ ( {O}_{1 : N} , {T}_{1 : N} , {S}_{1 : N} ; m ) . \qquad ( 12 )$$

The system may frame the selected message into a personalized energy saving recommendation (408). Once the best m* is selected, we frame it into an action recommendation. For this, we define two types of framing operators i.e., literal operator and relative operator, to mathematically map the simple generic message m_{s,o} to an action recommendation. The literal operator translates the message into a direct recommendation by suggesting users adjust the setpoint to the specific temperature c in Eq. (8). On the other hand, the relative operator phrases an indirect recommendation without mentioning the specific temperature. To help users adjust their setpoint without sacrificing comfort, we use the relative operator for framing messages related to the occupied states (i.e., s∈{“home”, “sleep” }).

Remark 1: In what follows we use the notation “<test>?<option1>:<option2>” as a shortcut for “if <test> is True, then <option1>, otherwise <option2>”. Also the binary operator “+” concatenates strings.

The literal operator [symbol] takes a simple generic message m_{s,o,c} for s=“away” and translates it to text as follows:

$$ℒ ( {m}_{s , o} ) = “ Why don ' t you move your ” + ( o = “ heat ” ) ? “ heating ” : “ cooling ” + “ setpoint closer to ” + c + “ ° F . when you are away ? ” . \qquad ( 13 )$$

The relative operator [symbol] takes m_{s,o,c} for s∈{“home”, “sleep” }, and it does not report c:

$$ℛ ( {m}_{s , o} ) = “ If you feel comfortable , why don ' t you ” + ( o = “ heat ” ) ? “ heating ” : “ cooling ” + “ your ” + ( o = “ heat ” ) ? “ heating ” : “ cooling ” + “ setpoint ” + “ when you ” + ( s = “ home ” ) : “ are home ” : “ sleep ? ” . \qquad ( 14 )$$

Then the intensity of the action recommendation is adjusted based on the level of ρ. For the message with ρ smaller than 5%, we provide an encouraging message such as “Keep going! You have a high score!” to complement the good performance and encourage users to keep up their energy conservation behavior. On the other hand, when ρ is higher than 30% for the away-related message, we frame the message with higher intensity to encourage residents to improve their energy conservation behavior (Table 2).

TABLE 2
Message framing with different intensity

| Simple | | |
|---|---|---|
| generic | | |
| message | ρ [%] | Message framing |
| All | ρ < 5 | Keep going! You have a high score! |
| m_{home, heat} | ρ ≥ 5 | If you feel comfortable, why don't you lower |
| | | your heating setpoint when you are at home? |
| m_{home, cool} | | If you feel comfortable, why don't you increase |
| | | your cooling setpoint when you are at home? |
| m_{sleep, heat} | | If you feel comfortable, why don't you lower |
| | | your heating setpoint when you sleep? |
| m_{sleep, cool} | | If you feel comfortable, why don't you increase |
| | | your cooling setpoint when you sleep? |
| m_{away, heat} | 5 ≤ ρ < 30 | Why don't you move your heating setpoint |
| | | closer to 66° F. when you are away? |
| | ρ ≥ 30 | Why don't you lower your heating setpoint to |
| | | 66° F. when you are away? |
| m_{away, cool} | 5 ≤ ρ < 30 | Why don't you move your cooling setpoint |
| | | closer to 82° F. when you are away? |
| | ρ ≥ 30 | Why don't you increase your cooling setpoint |
| | | to 82° F. when you are away? |

Referring back to FIG. 2, the system may prepare a community energy conservation game (206). The energy conservation game may be a collaborative social game that is designed to promote community-level energy savings. For the game, we adopt the Public Good Games (PGG) approach that promotes cooperative behaviors of a group of users with a shared goal and reward. This collaborative structure has been adopted in previous social energy game studies to encourage participants to reach common energy savings goals. These games accompany social norms and social proofs for nudging users toward collective behavioral changes to gain team-based rewards. Thus, the game leverages financial motivations with social proof motivations for energy conservation, drawing on the demonstrated power of social proof feedback in energy conservation. Our game incentivizes subsidized housing residents for achieving a shared goal that can contribute to reducing community energy usage. The building manager who is responsible for the community utility bills can benefit from this game strategy by having control over the goal and the incentives that affect user participation in reducing each households' HC energy usage.

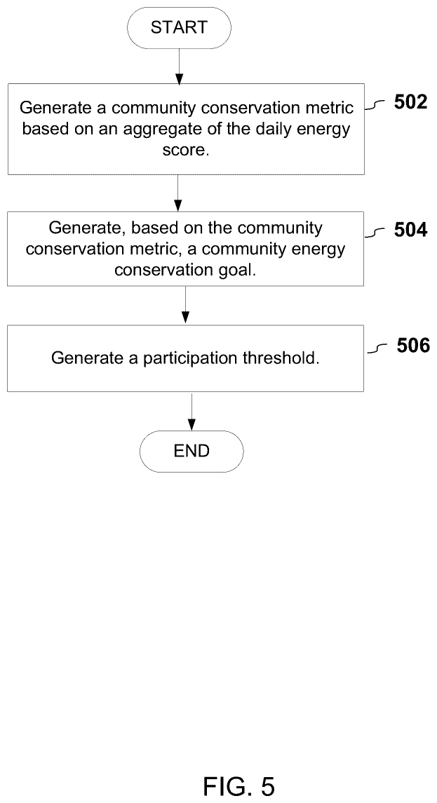

FIG. 5 illustrates example logic for preparing a community energy conservation game. The three major game elements such as the community goal (α_{goal}), personal participation threshold (α_{threshold}), and incentives (I) are generated every week. Each game constitutes four rounds of weekly games where the new game elements are calculated every Monday with the start of the week. The results of the weekly games are announced every Sunday. The detailed game rules and logic are described below.

The system may generate a conservation metric based on an aggregate of the daily energy scores (502). The community conservation metric may be an average of the previous period's energy scores for the households. The system may generate, based on the energy conservation metric, a community energy conservation goal (504). The community conservation score may change each period depending on the energy conservation of the community among other factors. By way of example, the first week's community goal (α_{goal,1}) is calculated by rounding up the previous week's community average energy score (α_{com,0}) to its nearest multiple of 5

$$( i . e . , {α}_{goal , 1} = 5 ⌈ \frac{{α}_{com , 0}}{5} ⌉ ,$$

where ┌x┐=min{k∈ [symbol] |k≤x}). From the second week, the goal increases every week by 5 points only if the community has achieved the goal in the previous round. Otherwise, the goal stays the same as the previous week. This is shown in Eq. (15) as follows:

$${α}_{goal , w} = \{ \begin{matrix}{α}_{goal , w - 1} + 5 , & if {α}_{goal , w - 1} \geq {α}_{goal , w - 1} \\ {α}_{goal , w - 1} , & otherwise\end{matrix} , \qquad ( 15 )$$

where α_{goal,w} is a community goal of the week w≥2, α_{goal,w-1} and α_{com,w-1} are the community goal and the average score of the previous week, respectively. To achieve the community goal, households are required to increase the community's average energy score above or equal to the goal by the end of the game week (i.e., Sunday).

The system may generate a participation threshold to govern participation in the game (506). To be qualified for the weekly reward, residents are required to keep their scores above or equal to the participation threshold at the end of the game week. This threshold is designed to prevent incentivizing free-riders who may earn rewards without any effort. The thresholds are always 5 points below the weekly community goal (i.e. α_{threshold}=α_{goal}−5).

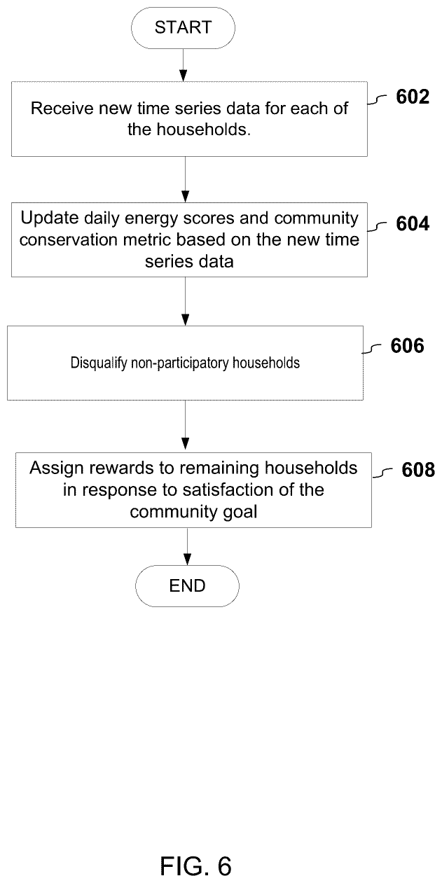

Referring back to FIG. 2, the system may execute the energy conservation game (208). FIG. 6 illustrates an example of energy conservation game execution. The system may receive new time series data for each of the households (602). The system may update daily energy scores and the community conservation metric based on the new time series data, as previously discussed. (604). Further, the system may disqualify any households based on the participation metric (606). The system may assign rewards to remaining households in response to satisfaction of the community goal (608).

The personal reward starts from $5 (i.e., I₀) in the first week and increases by $5 every week only if the community achieved the goal in the previous week. The new game round's reward will stay the same as the previous week if the community fails to meet the goal. We set the maximum limit of the weekly reward to $15 to prevent the reward from growing indefinitely. For w≥2, we can define the reward of the week w as below:

$${I}_{w} = \{ \begin{matrix}{I}_{w - 1} + 5 , & if {α}_{com , w - 1} \geq {α}_{goal , w - 1} \\ {I}_{w - 1} , & otherwise\end{matrix} . \qquad ( 16 )$$

The weekly rewards are stacked over 4 weeks and paid out at the end of the game set. Reward information may shared by the server infrastructure and sent to individual devices associated with each of the households.

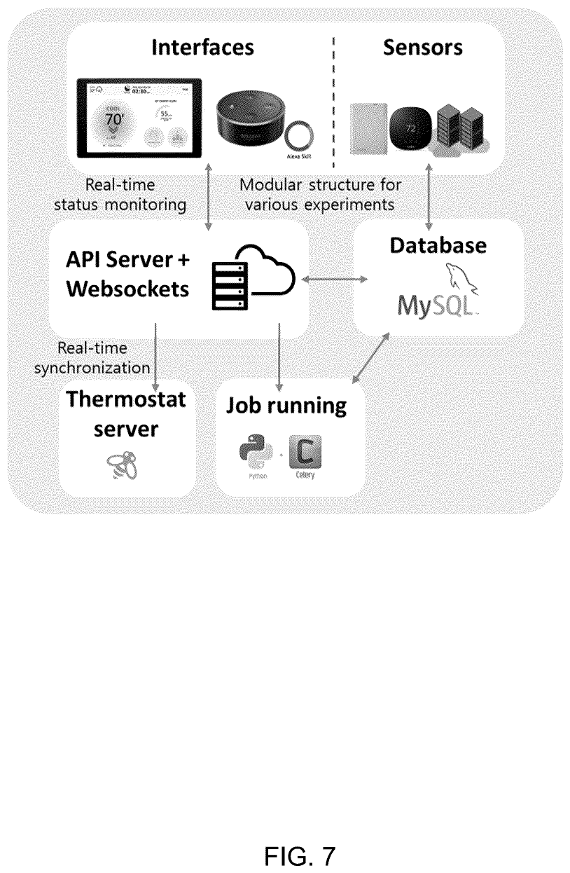

FIG. 7 illustrates an example of a server infrastructure. The architecture may support multi-modal communication among multiple software elements. The three main software elements that structure the system are 1) visual and voice user interfaces, 2) API server, and 3) MySQL database.

First, the two types of user interfaces i.e., visual and voice, were developed to provide users with manual and hands-free options to interact with the eco-feedback and smart thermostat. The visual user interface (UI) was designed a web application, which users can access via wall-mounted tablet displays in their homes. The front-end of the web application was developed using React in Javascript to selectively add or remove the modularized feedback elements based on the type of experiment, though other languages may be employed. It also incorporates the thermostat control panel that is paired with the Ecobee smart thermostat to control the home HC system. The voice user interface (VUI), accessible from the Amazon Echo Dot, can serve as a functional alternative to the tablet for controlling the thermostat and querying the feedback information.

Second, the API server was built on Google Cloud to enable real-time communications among the web and voice applications, connected devices, and a database with a common API. This unified API contributes to maintaining consistency across the web app and Alexa. The API was built with Falcon in Python, and exposes various REST endpoints for controlling the thermostat, interacting with feedback information, and applying changes. All calls to the API are logged to the unique table in the database, which helps understand the usage patterns across the project site. This also allows distinguishing between touch-based interaction and voice interactions.

The API also enables our web app to replicate Ecobee features in real-time by supporting data synchronization via polling every 5 seconds and on-demand WebSockets connections. The API and web socket server gets a dedicated host to increase the back-end performance by separating it from a compute-intensive data processing host. A message broker is used to help issue any on-demand tasks on the data processing host from the API host.

Third, the MySQL database was set up for managing multiple data sources such as user interactions, sensor readings, and computation results from the feedback algorithms. The user activities on the UI/VUI are captured in real-time. The data collected from the power meter and Ecobee thermostat are pushed to the database at a set frequency. The raw data is stored as-is for archival purposes, while processed data is incrementally generated every hour. This processed data goes into a feedback algorithm for generating users' daily eco-feedback.

The database structure was designed to enable adding or removing users and apartment units based on the move-in and out status of the residents. Similarly, the apartment units can be aggregated into teams and teams can be aggregated into a single group. Each group is assigned to a particular experiment. This hierarchy helps to conduct different experiments and the tablet application adapts automatically without any manual intervention.

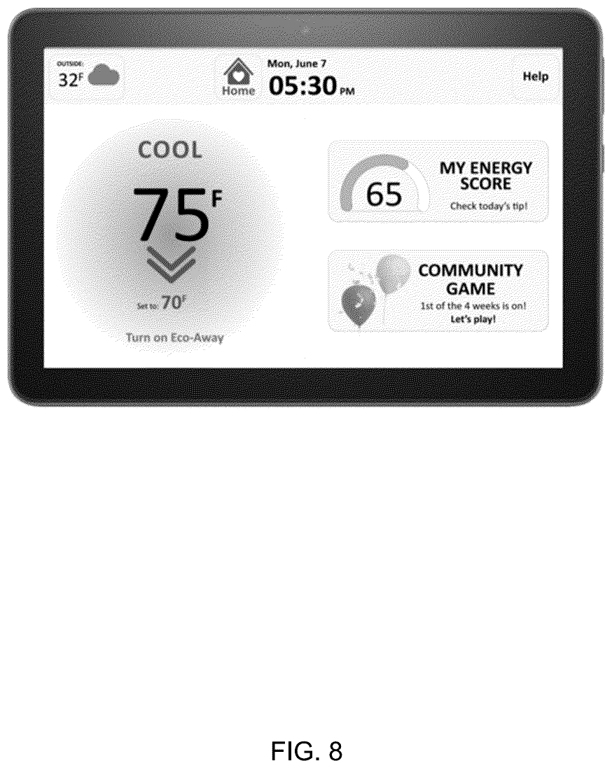

FIG. 8 illustrates an example of a main page of a user interface. The UI may follows a flat information architecture that prioritizes effective thermostat control and feedback visualization using comprehensive visual layouts. Our design process involved the following steps: 1) drawing wireframe and mockups, 2) developing prototype, and 3) iteratively reviewing and modifying the prototype. First, the overall layout of the UI structure was drafted into wireframe and then developed into mockups with refined visual elements using Adobe XD program. Then prototypes were developed and tested to simulate potential user interactions. During the process of 1) and 2), the designs were reviewed and updated by an internal testing group composed of graduate students, professors, and industry partners involved in the project. From this process, the web application was structured into six pages based on their major roles and the corresponding functions required to enhance the user experience.

The ‘Welcome page’ is designed to onboard first-time users with a virtual walk-through. This page pops up when the new user registers into the web application and allows users to go through a step-by-step thermostat schedule setup as well as introduction slides about the overall features of the application.

The ‘Main page’ is designed to provide an overview of users' current status. From the header of the ‘Main page’, users can view current weather information, a current thermostat schedule icon, time, and online user guides from the help button. By clicking the schedule icon on the header, users can view their weekly thermostat schedule and make any modifications. The page also allows users to navigate the other pages such as ‘Thermostat panel’, ‘My energy score’, and ‘Community game’. The ‘Thermostat panel’, which is located on the left side of ‘Main page’, allows users to manually set up their thermostat by selecting a desired system function, setpoint temperature, and the duration to hold the setpoint. It also provides an ‘Eco-Away’ button to help users efficiently setback or up the setpoint before they leave the residence.

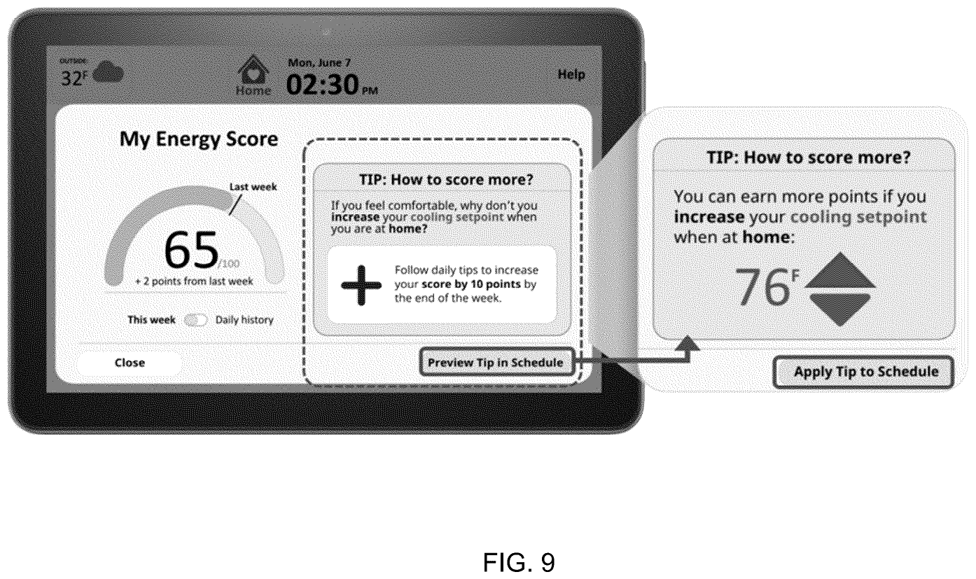

FIG. 9 illustrates an example of an energy score page for a graphical user interface. The ‘My energy score’ page provides personalized eco-feedback such as energy score and personal action tip. The score is presented every day along with the past 7 days' data to enable self-comparison. The personal tip is presented with an action button (i.e., ‘Apply Tip to Schedule’) that enables direct implementation of the tip on the user's thermostat schedule. When users click the button, a small thermostat control panel pops up so that users can adjust the tip-related setpoint temperature programmed in their thermostat schedule. To nudge the use of energy-conserving setpoints, the arrows in the control panel are only activated in energy-saving directions (e.g., downward arrow for heating, upward arrow for cooling). Once the tip is applied, users' new setpoint updates in the thermostat schedule and a short message shows up on the ‘Thermostat panel’ to confirm the tip activation.

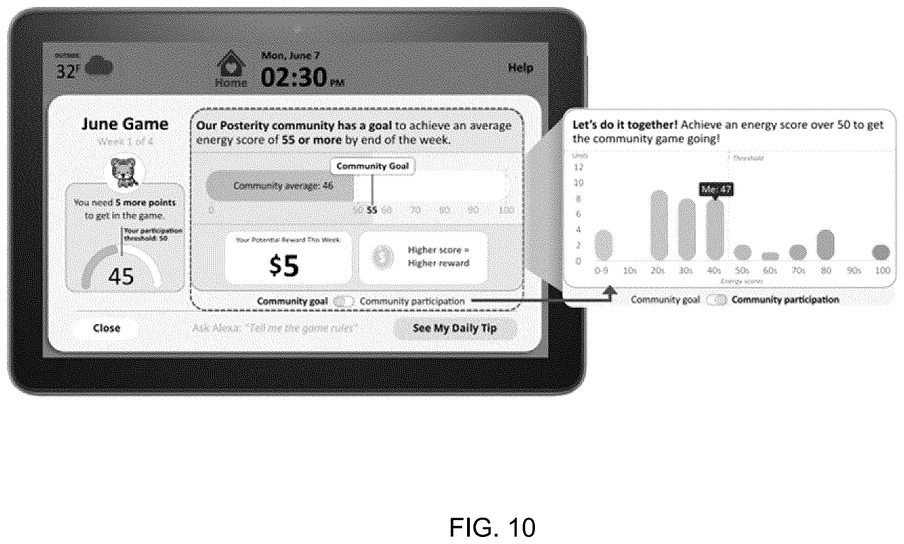

FIG. 10 illustrates an example of a community game page for a graphical user interface. The ‘Community game’ page provides an overview of the daily game status. On the page, the community's daily average energy score is visualized with a weekly community goal in a bar chart. The weekly reward is provided right below the community bar. The user's participation status is also visualized on the left side of the page with a custom avatar and a gauge bar comparing one's current energy score and the participation threshold. From the page, users can also see the distribution of their neighbors' energy scores by clicking the ‘community participation’ button. The navigation button to ‘My energy score’ is available on the page to nudge users to take actions to improve their performance in the game (i.e., ‘See My Daily Tip’).

Lastly, the ‘Screen saver’ is designed to visualize the summary of the current thermostat status and to periodically provide visual cues to nudge users' behavior changes. For this, the animating popups with personal tips and encouraging messages are provided every day at 9 am. During the game period, various types of popups that inform game status, social proof information (i.e., how the neighbors are doing), and Alexa commands are also provided.

### Voice User Interface

A VUI is designed to allow hands-free Ecobee control through voice interactions. Recent developments in systems tackling voice interactions have enabled dialogues ranging from open-ended to task-oriented commands, as well as handling of ambiguities and fuzziness of natural language. To ingest, process, and respond to a user request, tasks such as speech recognition, natural language understanding, dialog management, and natural language generation are performed. In this work, we developed a task-oriented VUI through a custom-developed application or ‘skill’ using the Alexa Skills Kit¹. This VUI tends to specific user invocations while addressing explicitly stated as well as ambiguous or fuzzy natural language commands. The skill enables users to interact with an Amazon Echo device, that processes and responds to user requests regarding energy control and monitoring.

Skill Development—The skill development process is divided into two parts, i.e., skill design and voice interaction model design. The skill design process requires defining and mapping user intents and utterances. User utterances describe particular goals as enunciated by the speaker. For example, when a speaker provides an utterance, ‘What is the temperature in the room?’, the associated intent class can be formalized as ‘Get Temperature’. The voice interaction model is designed to customize the responses of our VUI to specific user queries. The voice interaction model is hosted on the cloud using an on-demand computing service (Amazon Lambda, AWS).

Skill Workflow—Amazon's Alexa is a VUI that allows developers to create a conversational mechanism for interacting with an application. In this project, we use Alexa to give users access to both their application and the Ecobee through the Alexa smart speaker or any mobile device with the Alexa app. Through Alexa, we allow users to control their Ecobee thermostats and review their energy savings.

Through Alexa, users can query the Ecobee for device status, current temperature, temperature settings, the Ecobee's schedule, and outdoor temperature. The user can also control the functionality of the device by turning the device on and off, changing the mode of the device, and adjusting the temperature. Apart from these Ecobee controls, the interface also incorporates game controls. These include querying game rules, user status in the game, game-related tips, etc. The dialogues designed based on all possible voice interaction scenarios were reviewed by the internal testing group during demonstration sessions.

Temperature controls may be adjusted through explicit or implicit commands. The skill recognizes a range of phrases used in natural communication to control the temperature in the unit. For instance, a user can ask Alexa to change the temperature from 76 to 78° F. The user may issue the same adjustment by telling Alexa to increase the temperature by two degrees. Alternatively, the user may request a change using a fuzzy quantifier, such as “a little” without explicitly identifying the number of degrees for the adjustment, which will activate a fuzzy module for the temperature calculation. The user is also able to indicate a level of discomfort on a scale from freezing to burning up. Synonyms for each level on the scale are included to allow for easier and more fluid communication. Based on the level of stated discomfort, Alexa will change the set temperature of the Ecobee by increasing or decreasing the temperature by up to three degrees.

In addition to controlling the temperature, the user can use Alexa to interact with the application itself. Alexa can provide users with details about their thermostat usage, recommendations around improving performance, and instructions on how to use the application. The Alexa skill has been modified throughout this project to add various functions as well as provide more variability in conversation. It is possible to capture weekly aggregated interaction with the utilities provided in the Alexa Developer Console.

The logic illustrated in the flow diagrams may include additional, different, or fewer operations than illustrated. The operations illustrated may be performed in an order different than illustrated.

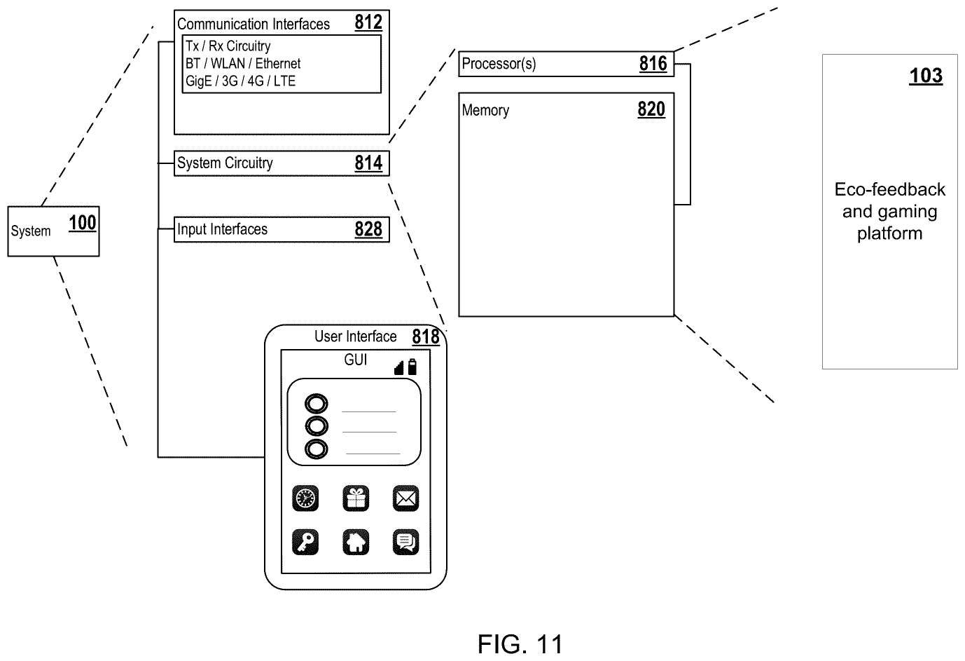

FIG. 11 illustrates a second example of the system 100. The system 100 may include communication interfaces 812, input interfaces 828 and/or system circuitry 814. The system circuitry 814 may include a processor 816 or multiple processors. Alternatively or in addition, the system circuitry 814 may include memory 820.

The processor 816 may be in communication with the memory 820. In some examples, the processor 816 may also be in communication with additional elements, such as the communication interfaces 812, the input interfaces 828, and/or the user interface 818. Examples of the processor 816 may include a general processor, a central processing unit, logical CPUs/arrays, a microcontroller, a server, an application specific integrated circuit (ASIC), a digital signal processor, a field programmable gate array (FPGA), and/or a digital circuit, analog circuit, or some combination thereof.

The processor 816 may be one or more devices operable to execute logic. The logic may include computer executable instructions or computer code stored in the memory 820 or in other memory that when executed by the processor 816, cause the processor 816 to perform the operations the eco-feedback and gaming platform 103 and/or the system 100. The computer code may include instructions executable with the processor 816.

The memory 820 may be any device for storing and retrieving data or any combination thereof. The memory 820 may include non-volatile and/or volatile memory, such as a random access memory (RAM), a read-only memory (ROM), an erasable programmable read-only memory (EPROM), or flash memory. Alternatively or in addition, the memory 820 may include an optical, magnetic (hard-drive), solid-state drive or any other form of data storage device. The memory 820 may include at least one of the eco-feedback and gaming platform 103 and/or the system 100. Alternatively or in addition, the memory may include any other component or subcomponent of the system 100 described herein.

The user interface 818 may include any interface for displaying graphical information. The system circuitry 814 and/or the communications interface(s) 812 may communicate signals or commands to the user interface 818 that cause the user interface to display graphical information. Alternatively or in addition, the user interface 818 may be remote to the system 100 and the system circuitry 814 and/or communication interface(s) may communicate instructions, such as HTML, to the user interface to cause the user interface to display, compile, and/or render information content. In some examples, the content displayed by the user interface 818 may be interactive or responsive to user input. For example, the user interface 818 may communicate signals, messages, and/or information back to the communications interface 812 or system circuitry 814.

The system 100 may be implemented in many different ways. In some examples, the system 100 may be implemented with one or more logical components. For example, the logical components of the system 100 may be hardware or a combination of hardware and software. The logical components may the eco-feedback and gaming platform 103 or any component or subcomponent of the system 100. In some examples, each logic component may include an application specific integrated circuit (ASIC), a Field Programmable Gate Array (FPGA), a digital logic circuit, an analog circuit, a combination of discrete circuits, gates, or any other type of hardware or combination thereof. Alternatively or in addition, each component may include memory hardware, such as a portion of the memory 820, for example, that comprises instructions executable with the processor 816 or other processor to implement one or more of the features of the logical components. When any one of the logical components includes the portion of the memory that comprises instructions executable with the processor 816, the component may or may not include the processor 816. In some examples, each logical component may just be the portion of the memory 820 or other physical memory that comprises instructions executable with the processor 816, or other processor(s), to implement the features of the corresponding component without the component including any other hardware. Because each component includes at least some hardware even when the included hardware comprises software, each component may be interchangeably referred to as a hardware component.

Some features are shown stored in a computer readable storage medium (for example, as logic implemented as computer executable instructions or as data structures in memory). All or part of the system and its logic and data structures may be stored on, distributed across, or read from one or more types of computer readable storage media. Examples of the computer readable storage medium may include a hard disk, a floppy disk, a CD-ROM, a flash drive, a cache, volatile memory, non-volatile memory, RAM, flash memory, or any other type of computer readable storage medium or storage media. The computer readable storage medium may include any type of non-transitory computer readable medium, such as a CD-ROM, a volatile memory, a non-volatile memory, ROM, RAM, or any other suitable storage device.

The processing capability of the system may be distributed among multiple entities, such as among multiple processors and memories, optionally including multiple distributed processing systems. Parameters, databases, and other data structures may be separately stored and managed, may be incorporated into a single memory or database, may be logically and physically organized in many different ways, and may implemented with different types of data structures such as linked lists, hash tables, or implicit storage mechanisms. Logic, such as programs or circuitry, may be combined or split among multiple programs, distributed across several memories and processors, and may be implemented in a library, such as a shared library (for example, a dynamic link library (DLL).

All of the discussion, regardless of the particular implementation described, is illustrative in nature, rather than limiting. For example, although selected aspects, features, or components of the implementations are depicted as being stored in memory(s), all or part of the system or systems may be stored on, distributed across, or read from other computer readable storage media, for example, secondary storage devices such as hard disks, flash memory drives, floppy disks, and CD-ROMs. Moreover, the various logical units, circuitry and screen display functionality is but one example of such functionality and any other configurations encompassing similar functionality are possible.

The respective logic, software or instructions for implementing the processes, methods and/or techniques discussed above may be provided on computer readable storage media. The functions, acts or tasks illustrated in the figures or described herein may be executed in response to one or more sets of logic or instructions stored in or on computer readable media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like. In one example, the instructions are stored on a removable media device for reading by local or remote systems. In other examples, the logic or instructions are stored in a remote location for transfer through a computer network or over telephone lines. In yet other examples, the logic or instructions are stored within a given computer and/or central processing unit (“CPU”).

Furthermore, although specific components are described above, methods, systems, and articles of manufacture described herein may include additional, fewer, or different components. For example, a processor may be implemented as a microprocessor, microcontroller, application specific integrated circuit (ASIC), discrete logic, or a combination of other type of circuits or logic. Similarly, memories may be DRAM, SRAM, Flash or any other type of memory. Flags, data, databases, tables, entities, and other data structures may be separately stored and managed, may be incorporated into a single memory or database, may be distributed, or may be logically and physically organized in many different ways. The components may operate independently or be part of a same apparatus executing a same program or different programs. The components may be resident on separate hardware, such as separate removable circuit boards, or share common hardware, such as a same memory and processor for implementing instructions from the memory. Programs may be parts of a single program, separate programs, or distributed across several memories and processors.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action sets a flag and a third action later initiates the second action whenever the flag is set.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

While various embodiments have been described, it will be apparent to those of ordinary skill in the art that many more embodiments and implementations are possible. Accordingly, the embodiments described herein are examples, not the only possible embodiments and implementations.

What is claimed is:

1. A method for generating and executing an eco-feedback and social energy game, the method comprising:
generating daily energy scores for a plurality of households by:
accessing the time series data collected from the thermostat of each household, the time series data respectively comprising HVAC operating modes, thermostat set points, and household occupancy states;
generating energy conservation behavior (ECB) metrics based on the time series data, wherein ECB is a function of the thermostat setpoint, the operation mode, and the occupancy state associated with each timestamp in the timeseries data;
generating, based on the ECB metrics, the daily energy scores for each of the households, respectively; and
preparing a community energy conservation game by:
generate a community conservation metric based on an aggregate of the daily energy score;
generate, based on the community conservation metric, a community energy conservation goal;
generate a participation threshold; and
executing an energy conservation game by:
receiving, from the plurality of households, updated time series data for each of the households;
update the daily energy scores and the community conservation metric based on the updated time series data;
determining a portion of the households are disqualified in response to an updated daily energy score being less than a participation threshold, wherein a remainder of the households are qualified; and
in response to the updated community conservation metric being greater or equal to the community energy conservation goal, assigning rewards to respective accounts associated with the qualified households.

2. The method of claim 1, wherein generating energy conservation behavior (ECB) metrics based on the time series data comprises:
calculating an ECB timeseries metric for each timestamp by:
applying a thermostat setpoint, a operation mode, and a household occupancy state to a mode-and-state-specific ECB function, wherein the mode-and-state-specific ECB is a sigmoid function for a plurality of modes; and
calculating the energy score of each household for the evaluation period, by:
using ECB timeseries metrics that accrue over a regular interval in an evaluation timeframe; and
averaging, over the evaluation timeframe, the timeseries ECB in response to the operation mode and the household occupancy state.

3. The method of claim 1, further comprising:
generating the personalized daily energy-saving recommendation for each of the households; and
outputting the personalized daily energy-saving recommendations.

4. The method of claim 3, wherein generating the personalized energy-saving action recommendation for each of the households based on the time series data comprises:
generating a plurality of messages, wherein the messages suggest changing a current setpoint to a recommended setpoint c for the given occupancy state s and operation mode o;
simulating a relative change in energy score for the messages by:
generating counterfactual scenarios for each of the plurality of messages, wherein each of the counterfactual scenarios assumes the household selecting the recommended setpoint for the operational mode and state in response to the message;
generating updated timeseries data for each of the counterfactual scenarios;
calculating, based on updated timeseries data, the potential energy scores that the households could have achieved in each of the counterfactual scenarios;
calculating, for each of the counterfactual scenarios, the relative change in energy score that could have resulted from the implementation of the message;
selecting, from the plurality of messages, a message with a greatest relative change in energy score relative change; and
framing the selected message into a personalized energy saving recommendation.

5. The method of claim 4, wherein framing the selected simple message into a personalized energy saving recommendation comprises:
generating a literal operator, wherein the operator translates the message into a contextualized action recommendation by suggesting users adjust the setpoint to the specific ideal temperature c;
generating a relative operator, wherein the relative operator phrases an indirect recommendation without mentioning the specific temperature;
mapping the selected message into an action recommendation either using the literal operator or relative operator, wherein the relative operator is used for the framing messages related to the occupied states and the literal operator is used for the away state.

6. The method of claim 3, wherein outputting the personalized daily energy-saving recommendations further comprises:
causing a device located in at least one of the households to display the personalized daily recommendations, communicating the personalized daily recommendations over a network, storing the personalized daily recommendations in a memory, or a combination thereof.

7. The method of claim 1, further comprising:
communicating a notification of at least one of the rewards to a device located in at least one of the qualified households.

8. A system, comprising:
a processor, the processor configured to:
generate daily energy scores for a plurality of households, wherein to generate the daily energy scores, the processor is configured to:
access the time series data collected from the thermostat of each household, the time series data respectively comprising HVAC operating modes, thermostat set points, and household occupancy states;
generate energy conservation behavior (ECB) metrics based on the time series data, wherein ECB is a function of the thermostat setpoint, the operation mode, and the occupancy state associated with each timestamp in the timeseries data;
generate, based on the ECB metrics, the daily energy scores for each of the households, respectively,
wherein the processor is further configured to:
prepare a community energy conservation game, wherein the community energy conservation game, the processor is configured to:
generate a community conservation metric based on an aggregate of the daily energy score;
generate, based on the community conservation metric, a community energy conservation goal;
generate a participation threshold,
wherein the processor is further configured to:
execute an energy conservation game by, wherein to execute the energy conservation game, the processor is configured to:
receive, from the plurality of households, updated time series data for each of the households;
update the daily energy scores and the community conservation metric based on the updated time series data;
determine a portion of the households are disqualified in response to an updated daily energy score being less than a participation threshold, wherein a remainder of the households are qualified; and
in response to the updated community conservation metric being greater or equal to the community energy conservation goal, assign rewards to respective accounts associated with the qualified households.

9. The system of claim 8, wherein to generate energy conservation behavior (ECB) metrics based on the time series data, the processor is further configured to:
calculate an ECB timeseries metric for each timestamp by applying a thermostat setpoint, a operation mode, and a household occupancy state to a mode-and-state-specific ECB function, wherein the mode-and-state-specific ECB is a sigmoid function for a plurality of modes; and
calculate the energy score of each household for the evaluation period, by using ECB timeseries metrics that accrue over a regular interval in an evaluation timeframe, and averaging, over the evaluation timeframe, the timeseries ECB in response to the operation mode and the household occupancy state.

10. The system of claim 8, wherein the processor is further configured to:
generate the personalized daily energy-saving recommendation for each of the households; and
output the personalized daily energy-saving recommendations.

11. The system of claim 10, wherein to generate the personalized energy-saving action recommendation for each of the households based on the time series data the processor is further configured to:
generate a plurality of messages, wherein the messages suggest changing a current setpoint to a recommended setpoint c for the given occupancy state s and operation mode o;
simulate a relative change in energy score for the messages by:
generating counterfactual scenarios for each of the plurality of messages, wherein each of the counterfactual scenarios assumes the household selecting the recommended setpoint for the operational mode and state in response to the message;
generating updated timeseries data for each of the counterfactual scenarios;
calculating, based on updated timeseries data, the potential energy scores that the households could have achieved in each of the counterfactual scenarios;
calculating, for each of the counterfactual scenarios, the relative change in energy score that could have resulted from the implementation of the message; and
selecting, from the plurality of messages, a message with a greatest relative change in energy score relative change.

12. The system of claim 11, wherein the processor is further configured to:
generate a literal operator, wherein the operator translates the message into a contextualized action recommendation by suggesting users adjust the setpoint to the specific ideal temperature c;
generate a relative operator, wherein the relative operator phrases an indirect recommendation without mentioning the specific temperature; and
map the selected message into an action recommendation either using the literal operator or relative operator, wherein the relative operator is used for the framing messages related to the occupied states and the literal operator is used for the away state.

13. The system of claim 10, wherein to output the personalized daily energy-saving recommendations, the processor is further configured to:
cause a device located in at least one of the households to display the personalized daily recommendations, communicating the personalized daily recommendations over a network, storing the personalized daily recommendations in a memory, or a combination thereof.

14. The system of claim 8, wherein the processor is further configured to:
communicate a notification of at least one of the rewards to a device located in at least one of the qualified households.
